(19) United States
(12) Patent Application Publication
(10) Pub. No.: US 2026/0305576 A1
(43) Pub. Date: Oct. 8, 2026

(54) PANTS-TYPE DISPOSABLE DIAPER FOR PETS

(71) Applicant: Unicharm Corporation, Shikokuchuo-City, Ehime (JP)

(72) Inventor: Daisuke KOMATSUBARA, Kanonji-shi, Kagawa (JP)

(21) Appl. No.: 19/482,996

(22) PCT Filed: May 26, 2023
(86) PCT No.: PCT/JP2023/019802

§ 371 Date: Nov. 10, 2025

(51) Int. Cl. A01K 23/00

(52) U.S. Cl. CPC A01K 23/00

(57) ABSTRACT

This pants-type disposable diaper (1) for pets comprises: an absorbent body (10) that has a vertical direction, a left-right direction, and a front-rear direction that intersect one other, and that is provided with an absorbent core (12) ; an abdominal-side waist part (20) that is positioned on the front side in the front-rear direction; and a back-side waist part (30) that is positioned on the rear side in the front-rear direction, wherein the abdominal-side waist part (20) and the back-side waist part (30) are joined by a pair of side joining parts (40) on both side parts in the left-right direction, and a tail insertion part (50) in which the tail can be inserted is provided in the absorbent body (10), the pants-type disposable diaper (1) for pets being characterized in that the absorbent core (12) is disposed on both sides of the tail insertion part (50) in the left-right direction.

### FIELD

The present disclosure relates to an underpants-shaped disposable pet diaper.

### BACKGROUND

Diapers for pets such as dogs and cats are known. For example, PIL 1 discloses an underpants-shaped disposable pet diaper including a waist region, a crotch region, a waist opening, a pair of leg openings, an absorbent core, and a tail insertion opening. In such an underpants-shaped disposable pet diaper, a plurality of waist stretchable elastic members are arranged in the waist region.

### CITATION LIST

### Patent Literature

[PTL 1] Japanese Patent Application Publication No. 2014-226110

### SUMMARY

### Technical Problem

In the underpants-shaped disposable pet diaper of PTL 1, the waist region includes a region with low stretching stress, thereby preventing excessive tightening of the pet's waist to improve the fit around the pet's waist. However, when underpants-shaped diapers are put on pets such as dogs and cats, in most cases, it is difficult for a diaper changer to put the diaper on a moving pet at an appropriate position while holding the pet. Specifically, for the underpants-shaped diapers, it is necessary that the pet's hind legs are first passed through the leg openings and the pet's tail is then passed through the tail insertion portion. Finally, the diaper is pulled up to fit the pet's tail and waist. Therefore, the fit of the underpants-shaped pet diapers still leaves room for improvement.

The present invention was achieved in light of conventional problems such as that described above, an aspect of the present invention is to provide an underpants-shaped disposable pet diaper that achieves an improved fit.

### Solution to Problem

A main aspect of the present disclosure for achieving the above-described aspect is an underpants-shaped disposable pet diaper having a vertical direction, a lateral direction, and a front-back direction that intersect with each other, the underpants-shaped disposable pet diaper including: an absorbent main body including an absorbent core; a ventral waist portion positioned on a front side in the front-back direction; and a dorsal waist portion positioned on a back side in the front-back direction, two lateral side portions of the ventral waist portion and two lateral side portions of the dorsal waist portion being joined by a pair of side-joining portions, the absorbent main body including a tail insertion portion through which a tail is passed, the absorbent core being provided on two lateral sides of the tail insertion portion.

Features of the present disclosure other than the above will become clear by reading the description of the present specification with reference to the accompanying drawings.

### Advantageous Effect of the Invention

According to the present disclosure, it is possible to provide an underpants-shaped disposable pet diaper that achieves an improved fit.

### BRIEF DESCRIPTION OF DRAWINGS

FIG. 1 is a schematic perspective view of an underpants-shaped disposable pet diaper 1 as viewed from a dorsal side.

FIG. 2 is a schematic plan view of the diaper 1 in an unfolded and stretched state as viewed from a skin side.

FIG. 3A is a schematic cross-sectional view taken along a line I-I in FIG. 2, and FIG. 3B is a schematic cross-sectional view taken along a line II-II in FIG. 2.

FIGS. 4A to 4C are illustrative views of operations for putting on the diaper 1.

FIGS. 5A and 5B are schematic plan views of a part of the diaper 1 in the unfolded and stretched state, as viewed from the skin side.

FIG. 6 is a schematic plan view of a part of the diaper 1 in the unfolded and stretched state, as viewed from the skin side.

FIG. 7 is an illustrative view of an arrangement of a constricted portion 12C of an absorbent core 12 according to a modification.

FIG. 8 is a plan view of the diaper 1 in the stretched state, as viewed from a ventral side.

FIG. 9 is a schematic plan view of the diaper 1 in the unfolded and stretched state, as viewed from the skin side.

FIG. 10 is a schematic perspective view of the diaper 1 in an underpants-shaped state, as viewed from the dorsal side.

FIG. 11A is an illustrative view of an arrangement of a tail insertion portion 50 and the absorbent core 12, and

FIG. 11B is an illustrative view of adhesives provided between the tail insertion portion 50 and the absorbent core 12.

FIG. 12 is an illustrative view of an arrangement of a tail insertion portion 50 according to a modification.

FIG. 13A is a schematic plan view illustrating fixing of two longitudinal end portions of a leakproof-wall portion 16, and FIG. 13B is a schematic cross-sectional view taken along a line III-III in FIG. 13A.

FIG. 14 is an illustrative view of the diaper 1 according to a modification.

### DESCRIPTION OF EMBODIMENTS

At least the following matters will become clear with the description of this specification and the attached drawings. Aspect 1 is an underpants-shaped disposable pet diaper having a vertical direction, a lateral direction, and a front-back direction that intersect with each other, the underpants-shaped disposable pet diaper including: an absorbent main body including an absorbent core; a ventral waist portion positioned on a front side in the front-back direction; and a dorsal waist portion positioned on a back side in the front-back direction, two lateral side portions of the ventral waist portion and two lateral side portions of the dorsal waist portion being joined by a pair of side-joining portions, the absorbent main body including a tail insertion portion through which a tail is passed, the absorbent core being provided on two lateral sides of the tail insertion portion.

According to Aspect 1, the absorbent core exists on the two lateral sides of the tail insertion portion, thereby improving the stiffness of the tail insertion portion on the two lateral sides thereof. As a result, the shape of the tail insertion portion is likely to be maintained, which allows the pet's tail to be more smoothly passed through the tail insertion portion.

Aspect 2 is the underpants-shaped disposable pet diaper of Aspect 1, wherein, in an unfolded and stretched state, the absorbent core and the dorsal waist portion have an overlapping portion as viewed in a thickness direction of the underpants-shaped disposable pet diaper.

According to Aspect 2, after the tail has been passed through the tail insertion portion, when the diaper is further pulled up while holding the dorsal waist portion with the pet's tail passed through the tail insertion portion, the dorsal waist member and the absorbent core have the overlapping portion, thereby making the pull-up force more likely to be transmitted to the absorbent core. Thus, the diaper is pulled up more easily. As a result, the tail is easily fitted.

Aspect 3 is the underpants-shaped disposable pet diaper of Aspect 1 or 2, wherein, in the dorsal waist portion, when a region between the pair of side-joining portions refers to a dorsal side-joining-portion region, the absorbent core and the dorsal side-joining-portion region have an overlapping portion as viewed in a thickness direction of the underpants-shaped disposable pet diaper.

According to Aspect 3, when the diaper is further pulled up while holding the dorsal waist portion with the pet's tail passed through the tail insertion portion, the dorsal side-joining-portion region and the absorbent core have the overlapping portion, thereby making the pull-up force more likely to be transmitted to the absorbent core. Thus, the diaper is pulled up more easily. As a result, the tail is more easily fitted.

Aspect 4 is an underpants-shaped disposable pet diaper having a vertical direction, a lateral direction, and a front-back direction that intersect with each other, the underpants-shaped disposable pet diaper including: an absorbent main body including an absorbent core; a ventral waist portion positioned on a front side in the front-back direction; and a dorsal waist portion positioned on a back side in the front-back direction, two lateral side portions of the ventral waist portion and two lateral side portions of the dorsal waist portion being joined by a pair of side-joining portions, the absorbent main body including a tail insertion portion through which a tail is passed, in an unfolded and stretched state, the absorbent core including a constricted portion located between two longitudinal end portions of the absorbent core, a width of the constricted portion in the lateral direction being narrower than a maximum width of the absorbent core in the lateral direction.

According to Aspect 4, the presence of the constricted portion avoids the absorbent core from getting caught on the hind legs, which bend in a V-shape, when the diaper is pulled up. Thus, the diaper is more easily fitted properly.

Aspect 5 is the underpants-shaped disposable pet diaper of Aspect 4, wherein, in an unfolded and stretched state, the constricted portion and the ventral waist portion have an overlapping portion as viewed in a thickness direction of the underpants-shaped disposable pet diaper.

According to Aspect 5, the portions where the ventral waist portion and the absorbent main body intersect with each other are the regions where the pet's hind legs are most likely to get caught when the diaper is pulled up with the hind legs passed through the diaper. In the case where the absorbent core exists in such regions, the diaper may be hindered from being pulled up. The constricted portion of the absorbent core exists in the above-mentioned regions, thereby reducing the stiffness of the absorbent main body in such regions. As a result, the pet's legs are less likely to get caught.

Aspect 6 is the underpants-shaped disposable pet diaper of Aspect 4, wherein, in an unfolded and stretched state, the constricted portion and the ventral waist portion do not overlap as viewed in a thickness direction of the underpants-shaped disposable pet diaper.

According to Aspect 6, when the diaper is put on a male animal in particular, due to the shape of male genitalia, urine is likely to be excreted more on the ventral side compared to the crotch side. Thus, it is necessary to secure a sufficient absorption area on the ventral side. The constricted portion does not overlap the ventral waist portion, thereby increasing the width of the absorbent core on the ventral side. As a result, leakage is likely to be prevented.

Aspect 7 is the underpants-shaped disposable pet diaper of any one of Aspects 4 to 6, wherein, in an unfolded and stretched state, the front side corresponds to a longitudinal one side of the underpants-shaped disposable pet diaper, the back side corresponds to a longitudinal other side of the underpants-shaped disposable pet diaper, and a back end of the constricted portion is positioned on the back side with respect to a longitudinal central position of the underpants-shaped disposable pet diaper.

According to Aspect 7, in the case where the constricted portion does not extend backward (toward the dorsal side) beyond the longitudinal central position, the pet's hind legs are likely to get caught on the absorbent core in response to movement of the hind legs. This may cause a force of shifting of the diaper. Then, the constricted portion extends to the back side beyond the longitudinal central position, thereby reducing exertion of the force of shifting caused by movement of the pet's hind legs when the hind legs get caught on the absorbent core.

Aspect 8 is the underpants-shaped disposable pet diaper according to Aspect 7, wherein, in the longitudinal direction, concerning the constricted portion, a length from the longitudinal central position to a front end of the constricted portion is longer than a length from the longitudinal central position to the back end of the constricted portion.

According to aspect 8, concerning the constricted portion, the length from the longitudinal central position to the front end is long, thereby reducing interference with movement of the pet's legs on both the front side (ventral side) and the back side (dorsal side). This can suppress shifting of the diaper caused by the pet's legs getting caught on the absorbent core.

Aspect 9 is the underpants-shaped disposable pet diaper of any one of Aspects 1 to 8, wherein, in a stretched state, and in the vertical direction, a length from a lower end of each of the side-joining portions to a lower end of the underpants-shaped disposable pet diaper is longer than a length from an upper end of each the side-joining portions to the lower end of each of the side-joining portions.

According to Aspect 9, the length from the lower end of each of the side-joining portions to the lower end of the underpants-shaped disposable pet diaper corresponds to the length of each leg opening. With such a configuration in which the leg openings are long, the pet's legs are more smoothly passed through the leg openings and the diaper is also easily pulled up. In addition, the area covering the pet's waist is reduced, which improves the comfort for the pet during usage.

Aspect 10 is the underpants-shaped disposable pet diaper of any one of Aspects 1 to 9, wherein, a ventral waist member constituting the ventral waist portion and a dorsal waist member constituting the dorsal waist portion are separate members, and in a stretched state, and in the vertical direction, a length of the ventral waist member is shorter than a length of the dorsal waist member.

According to Aspect 10, in the case where the length of the ventral waist member is excessively long, the pet's hind legs may get caught on the waist member during passage of the pet's hind legs. However, reducing the length of the ventral waist member avoids interference with the passage of the pet's legs.

Aspect 11 is the underpants-shaped disposable pet diaper of Aspect 10, wherein, in an unfolded and stretched state, the ventral waist member and the dorsal waist member each have a rectangular shape in a plan view.

According to Aspect 11, the rectangular waist members can further reduce the possibility that the hind legs may get caught at the time of passage of the hind legs.

Aspect 12 is the underpants-shaped disposable pet diaper of any one of Aspects 1 to 11, wherein, in an unfolded and stretched state, when a ventral side-joining-portion region refers to a region between the pair of side-joining portions in the ventral waist portion, and when a dorsal side-joining-portion region refers to a region between the pair of side-joining portions in the dorsal waist portion, a length over which the ventral side-joining-portion region and the absorbent main body overlap with respect to a longitudinal direction of the underpants-shaped disposable pet diaper is longer than a length over which the dorsal side-joining-portion region and the absorbent main body overlap with respect to the longitudinal direction.

According to Aspect 12, when the diaper is put on the male animal in particular, due to the shape of the male genitalia, urine is likely to be excreted more on the ventral side. However, with the above-mentioned configuration, a sufficient absorption area can be secured on the ventral side, and at the same time, contraction of the diaper on the dorsal side, where the pet has thick fur, is less likely to be hindered. As a result, the diaper is less likely to shift, and leakage is less likely to occur.

Aspect 13 is the underpants-shaped disposable pet diaper of any one of Aspects 1 to 12, wherein in an unfolded and stretched state, when a ventral side-joining-portion region refers to a region between the pair of side-joining portions in the ventral waist portion, and when a dorsal side-joining-portion region refers to a region between the pair of side-joining portions in the dorsal waist portion, a length over which the ventral side-joining-portion region and the absorbent core overlap with respect to a longitudinal direction of the underpants-shaped disposable pet diaper is longer than a length over which the dorsal side-joining-portion region and the absorbent core overlap with respect to the longitudinal direction.

According to Aspect 13, when the diaper is put on the male animal in particular, due to the shape of the male genitalia, urine is likely to be excreted more on the ventral side. However, with the above-mentioned configuration, a sufficient absorption area can be secured on the ventral side, and at the same time, contraction of the diaper on the dorsal side, where the pet has thick fur, is less likely to be hindered. As a result, the diaper is less likely to shift, and leakage is less likely to occur.

Aspect 14 is the underpants-shaped disposable pet diaper of any one of Aspects 1 to 13, wherein, when a crotch-side region refers to a region below the pair of side-joining portions in the vertical direction, the tail insertion portion is positioned on a lower region of two regions obtained by dividing the crotch-side region in the vertical direction.

According to Aspect 14, it becomes easier to achieve an appropriate position of the tail insertion portion in conformity with the respective body shapes of pets.

Aspect 15 is the underpants-shaped disposable pet diaper of any one of Aspects 1 to 14, wherein, a post-handling tape is provided on a non-skin side of the dorsal waist portion, the post-handling tape being used to hold the underpants-shaped disposable pet diaper in a rolled-up state when disposing of the underpants-shaped disposable pet diaper after use.

According to Aspect 15, urine excreted in the diaper is more likely to flow toward the front (ventral) side relative to the crotch portion of the diaper. Then, the diaper after use is rolled up with the ventral waist portion facing inward and the post-handling tape is finally fastened at the back side. Thus, the diaper changer can perform post-handling of the diaper without touching urine.

Aspect 16 is the underpants-shaped disposable pet diaper of any one of Aspects 1 to 15, wherein, the ventral waist portion and the dorsal waist portion each include a plurality of waist elastic members, the plurality of waist elastic members stretching and contracting in the lateral direction, the underpants-shaped disposable pet diaper in an unfolded state has a longitudinal direction, a lateral direction, and a thickness direction that intersect with each other, the underpants-shaped disposable pet diaper includes a pair of leakproof-wall portions provided on two lateral sides of the absorbent main body, the pair of leakproof-wall portions being capable of rising toward a skin side in the thickness direction, ventral end portions of the pair of leakproof-wall portions in the longitudinal direction are fixed by a pair of ventral-end-portion fixing portions, respectively, such that the leakproof-wall portions do not rise toward a skin side of the absorbent main body, dorsal end portions of the pair of leakproof-wall portions in the longitudinal direction are fixed by a pair of dorsal-end-portion fixing portions, respectively, such that the leakproof-wall portions do not rise toward the skin side of the absorbent main body, and in the longitudinal direction, an inward end of each of the ventral-end-portion fixing portions is positioned inside an innermost elastic member among the plurality of waist elastic members provided in the ventral waist portion.

According to Aspect 16, the leakproof-wall portions rise up in response to contraction of the waist elastic members of the ventral waist portion, thereby preventing leakage. In the case where, in each of the leakproof-wall portions, the inward end of the ventral-end-portion fixing portion is positioned outside the innermost waist elastic member in the longitudinal direction, the leakproof-wall portions are less likely to rise up. However, the inward end of the ventral-end-portion fixing portion is positioned inside the innermost waist elastic member in the longitudinal direction, the leakproof-wall portions more easily rise up.

Aspect 17 is the underpants-shaped disposable pet diaper of Aspect 16, wherein, in the longitudinal direction, the inward end of each of the ventral-end-portion fixing portions is positioned inside an inward end of the ventral waist portion.

According to Aspect 17, the leakproof-wall portions rise up in response to contraction of the waist elastic members of the ventral waist portion, thereby preventing leakage. In the case where, in each of the leakproof-wall portions, the inward end of the ventral-end-portion fixing portion is positioned outside the inward end of the ventral waist elastic member in the longitudinal direction, the leakproof-wall portions are less likely to rise up. However, the inward end of the ventral-end-portion fixing portion is positioned inside the inward end of the ventral waist member, the leakproof-wall portions more easily rise up.

Aspect 18 is the underpants-shaped disposable pet diaper of any one of Aspects 1 to 17, further comprising an indicator changing colors upon contact with excrement, wherein, in an unfolded and stretched state, the indicator is provided to span a longitudinal central position of the underpants-shaped disposable pet diaper.

According to Aspect 18, the indicator is provided so as to span the longitudinal central position of the underpants-shaped disposable pet diaper, which allows the diaper changer to easily visually recognize changes in the indicators in the state where the diaper is put on a pet.

Aspect 19 is the underpants-shaped disposable pet diaper of Aspect 18, wherein, the indicator and the tail insertion portion have an overlapping portion as viewed in a thickness direction of the underpants-shaped disposable pet diaper.

According to Aspect 19, the indicator extends to a position where the indicator overlaps the tail insertion portion, which allows the diaper changer to more easily visually recognize changes of the indicator.

Aspect 20 is the underpants-shaped disposable pet diaper of Aspect 18 or 19, wherein, the front side corresponds to a longitudinal one side of the underpants-shaped disposable pet diaper, the back side corresponds to a longitudinal other side of the underpants-shaped disposable pet diaper, and in the longitudinal direction, a back end of the indicator is positioned on the front side with respect to a back end of the absorbent core.

According to Aspect 20, the indicator extends to a position where the indicator overlaps the tail insertion portion, which allows the diaper changer to more easily visually recognize changes of the indicator.

Aspect 21 is the underpants-shaped disposable pet diaper of any one of Aspects 1 to 20, wherein, in an unfolded and stretched state, in the lateral direction, a distance from an outer edge of the tail insertion portion to the absorbent core provided on the two lateral sides of the tail insertion portion is longer than a maximum thickness of the absorbent core.

According to Aspect 21, the distance from the outer edge of the tail insertion portion to the absorbent core makes it possible to prevent tear and leakage of the sheet members positioned between the outer edge and the absorbent core.

Aspect 22 is the underpants-shaped disposable pet diaper of Aspect 21, wherein, a hot-melt adhesive is provided in a region from the outer edge of the tail insertion portion to the absorbent core provided on the two lateral sides of the tail insertion portion, the hot-melt adhesive joining a non-skin-side surface of a skin-side sheet member and a skin-side surface of a non-skin-side sheet member, the skin-side sheet member being provided on a skin side with respect to the absorbent core, the non-skin-side sheet member being provided on a non-skin side with respect to the absorbent core.

According to Aspect 22, the above-mentioned region is joined with the hot-melt adhesive, thereby making the absorbent core less likely to be exposed from the tail insertion portion to the outside.

Aspect 23 is the underpants-shaped disposable pet diaper of any one of Aspects 1 to 22, wherein, in an unfolded and stretched state, the absorbent core includes a constricted portion located between two longitudinal end portions of the absorbent core, a width of the constricted portion in the lateral direction is narrower than a maximum width of the absorbent core in the lateral direction, the front side corresponds to a longitudinal one side of the underpants-shaped disposable pet diaper, the back side corresponds to a longitudinal other side of the underpants-shaped disposable pet diaper, and a back end of the constricted portion is positioned on the front side with respect to a back end of the tail insertion portion.

According to Aspect 23, in the case where the constricted portion extends beyond the back end of the tail insertion portion, the range where the absorbent core exists on the two lateral sides of the tail insertion portion is reduced, which may make it difficult to maintain the shape of the tail insertion portion. On the other hand, in the case where the constricted portion does not extend on the dorsal side beyond the longitudinal central position, the absorbent core may interfere with movement of the pet's legs. The constricted portion extends on the front side beyond the back end of the tail insertion portion, thereby making both the maintenance of the shape of the tail insertion portion and smooth passage of the pet's legs more likely to be achieved.

Aspect 24 is the underpants-shaped disposable pet diaper of any one of Aspects 1 to 22, wherein, in an unfolded and stretched state, the absorbent core includes a constricted portion located between two longitudinal end portions of the absorbent core, a width of the constricted portion in the lateral direction is narrower than a maximum width of the absorbent core in the lateral direction, the front side corresponds to a longitudinal one side of the underpants-shaped disposable pet diaper, the back side corresponds to a longitudinal other side of the underpants-shaped disposable pet diaper, and the tail insertion portion is positioned on the back side with respect to a back end of the constricted portion.

According to Aspect 24, since the tail insertion portion does not overlap the constricted portion, a greater amount of the absorbent core can be secured on the two lateral sides of the tail insertion portion. As a result, when the diaper is pulled up, the pull-up force is more easily transmitted to the region around the tail insertion portion.

Aspect 25 is the underpants-shaped disposable pet diaper of Aspect 24, wherein, in the longitudinal direction, a length from the back end of the constricted portion to a front end of the tail insertion portion is shorter than a length from the front end of the tail insertion portion to a back end of the tail insertion portion.

According to Aspect 25, in the case where the tail insertion portion does not overlap the constructed portion, the pull-up force is more easily transmitted to the tail insertion portion. On the other hand, the presence of the constricted portion improves the fit of the leg openings of the diaper. Thus, it is preferable that the constricted portion is provided up to a position close to the tail insertion portion, thereby reducing the likelihood of interfering with movement of the legs.

### Embodiment

Hereinafter, an underpants-shaped disposable pet diaper according to an embodiment of the present disclosure will be described with reference to the drawings.

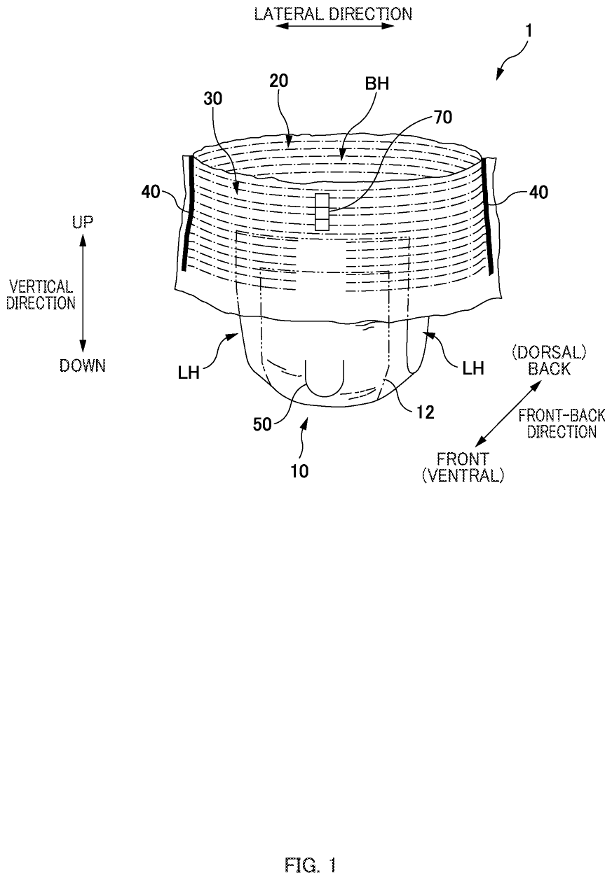

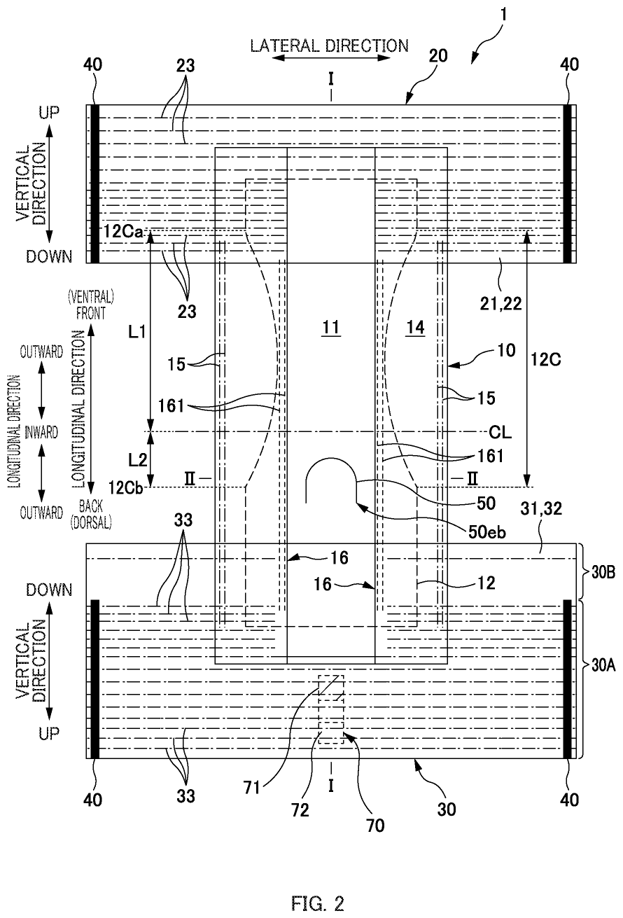

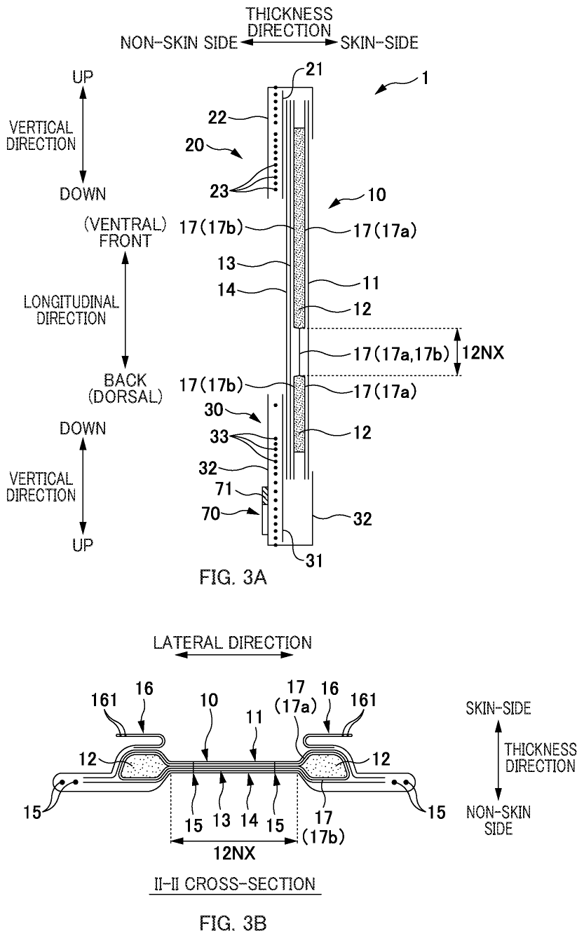

FIG. 1 is a schematic perspective view of an underpants-shaped disposable pet diaper 1 (hereinafter, also referred to as a “diaper 1”), as viewed from the dorsal side. FIG. 2 is a schematic plan view of the diaper 1 in the unfolded and stretched state as viewed from the skin side. FIG. 3A is a schematic cross-sectional view of the diaper 1 taken along a line I-I in FIG. 2, and FIG. 3B is a a schematic cross-sectional view of the diaper 1 taken along a line II-II in FIG. 2.

The underpants-shaped disposable pet diaper 1 is a diaper for pets. In the present specification, the term “pets” broadly include vertebrates and invertebrates, and typically include domestic pets such as dogs, cats, rabbits, and hamsters.

The unfolded state of the diaper 1 is a state in which a pair of side-joining portions 40 provided on both side portions of the diaper 1 is separated apart and the diaper 1 is unfolded flat. The stretched state of the diaper 1 is a state in which elastic members of the diaper 1 are stretched to the extent that wrinkles formed in the diaper 1 are substantially no longer visible. Specifically, it is a state in which the diaper 1 is stretched such that the lengths of the constituent members thereof match or are close to the dimensions of the members on their own (i.e., the dimensions in a state where the stretchability of the elastic members is not exhibited).

The diaper 1 in the underpants-shaped state shown in FIG. 1 has a vertical direction, a lateral direction, and a front-back direction, and includes a waist opening BH and a pair of leg openings LH. In the vertical direction, the waist side corresponds to the upper side, and the crotch side corresponds to the lower side. In the front-back direction, the front side corresponds to the ventral side of a pet, and the back side corresponds to the dorsal side of the pet. The lateral direction is a direction conforming to the pet's waist. As shown in FIGS. 3A and 3B, the direction in which the constituent members of the diaper 1 are overlaid on each other is referred to as a thickness direction. In the thickness direction, the side that faces a skin surface of the pet during usage of the diaper 1 is referred to as the skin side, and the opposite side is referred to as the non-skin side. In addition, when the diaper 1 is in the unfolded state as shown in FIG. 2, the diaper 1 has the longitudinal direction, the lateral direction, and the thickness direction (in FIG. 2, a direction passing through the paper plane) that intersect with each other. The longitudinal direction is a direction that conforms to the vertical direction and also connects the pet's ventral side to dorsal side. That is, a longitudinal one side of the diaper 1 corresponds to the front side in the front-back direction, and a longitudinal other side of the diaper 1 corresponds to the back side in the front-back direction. The lateral direction conforms to that of the diaper 1 in the underpants-shaped state shown in FIG. 1.

The diaper 1 includes: an absorbent main body 10; a ventral waist portion 20 that covers the pet's ventral portion; and a dorsal waist portion 30 that covers the pet's dorsal portion and is a separate member from the ventral waist portion 20. Therefore, the diaper 1 of the present embodiment is a so-called three-piece type of diaper, and in the portion of the absorbent main body 10 located below the ventral waist portion 20 and the dorsal waist portion 30, the non-skin-side surface of the absorbent main body 10 is exposed to the outside.

As illustrated in FIGS. 2 and 3A, the non-skin-side surface of the front-side end portion of the absorbent main body 10 in the longitudinal direction is joined to the skin-side surface of the ventral waist portion 20 with an adhesive or the like, and the non-skin-side surface of the back-side end portion of the absorbent main body 10 in the longitudinal direction is joined to the skin-side surface of the dorsal waist portion 30 with an adhesive or the like. In the diaper 1 in the unfolded state shown in FIG. 2, the absorbent main body 10 is folded one time such that the ventral waist portion 20 and the dorsal waist portion 30 face each other, and two lateral side portions of the ventral waist portion 20 and two lateral side portions of the dorsal waist portion 30 are joined by welding (e. g., heat welding or ultrasonic welding) or the like, thereby forming the pair of side-joining portions 40. As a result, the diaper 1 in an underpants-shaped state is obtained.

The absorbent main body 10 includes: an absorbent core 12 that absorbs excrement; a liquid-permeable top sheet 11 provided on the skin side with respect to the absorbent core 12; a liquid-impermeable back sheet 13 provided on the non-skin side with respect to the absorbent core 12; and an exterior sheet 14. They adhere with an adhesive or the like. Examples of the absorbent core 12 include an absorbent core obtained by shaping liquid-absorbent fibers, such as pulp fibers containing superabsorbent polymer, into a predetermined shape. The absorbent core 12 may be covered with a core-wrapping sheet 17 such as liquid-permeable tissue paper, nonwoven fabric, or the like. Other examples of the absorbent core 12 include an SAP sheet obtained by affixing an SAP layer to a hydrophilic sheet, an air-laid sheet in which liquid absorbent fibers are formed into a sheet by an air-laid method, and the like.

In addition, the absorbent main body 10 includes, in two lateral side portions thereof, leg elastic members 15 such as elastic strings. The leg elastic members 15 stretch and contract in the longitudinal direction (vertical direction). As a result, the diaper 1 fits around the pet's legs.

In addition, the absorbent main body 10 includes, in two lateral side portions thereof, a pair of leakproof-wall portions 16 that is capable of rising toward the skin side. As an example, in the present embodiment, the pair of leakproof-wall portions 16 is formed as follows: the exterior sheet 14 constituting the exterior of the absorbent main body 10 is folded at plurality of positions along the longitudinal direction such that two lateral side portions of the exterior sheet 14 are located on the skin-side surface of the top sheet 11 (FIG. 3B); and in such folded portions, leakproof-wall elastic members 161 (e.g., elastic strings) that stretch and contract in the longitudinal direction are provided.

As shown in FIG. 3A, the ventral waist portion 20 includes a skin-side sheet 21, a non-skin-side sheet 22, and a plurality of waist elastic members 23, and the dorsal waist portion 30 includes a skin-side sheet 31, a non-skin-side sheet 32, and a plurality of waist elastic members 33. The skin-side sheets 21, 31 are each made of soft nonwoven fabric or the like. The plurality of waist elastic members 23, 33 such as elastic strings stretch and contract in the lateral direction. In the ventral waist portion 20 and the dorsal waist portion 30, the plurality of waist elastic members 23, 33 are arranged in the vertical direction at intervals, and are fixed in a state of being stretched in the lateral direction. Accordingly, the ventral waist portion 20 and the dorsal waist portion 30 can stretch and contract in the lateral direction, and fit around the pet's waist.

As shown in FIG. 2, in the diaper 1 in the unfolded and stretched state, a ventral waist member constituting the ventral waist portion 20 and a dorsal waist member constituting the dorsal waist portion 30 are each rectangular in a plan view. The ventral waist portion 20 has a vertical length that is substantially the same as that of each side-joining portion 40, and the dorsal waist portion 30 includes a waist-side portion 30A and a crotch-side portion 30B. The waist-side portion 30A is a portion that overlaps the ventral waist portion 20, and the crotch-side portion 30B is a portion that extends downward relative to the waist-side portion 30A (below the side-joining portions 40). The ventral waist member constituting the ventral waist portion 20 and the dorsal waist member constituting the dorsal waist portion 30 may have different planar shapes. In addition, the vertical length of the ventral Waist portion 20 and the vertical length of the dorsal waist portion 30 may be the same.

The absorbent main body 10 includes a tail insertion portion 50 through which the pet's tail can be passed. The tail insertion portion 50 may be a cutout having a substantially U-shape, for example. The shape of the tail insertion portion 50 is not limited to the substantially U-shape, but may be semicircular, rectangular, trapezoidal, polygonal or elliptical shape. When the tail insertion portion 50 is formed by cutting, the shape is not limited to the above-mentioned shapes. For example, the cutout may have a cross shape. The cutout of the tail insertion portion 50 may be a continuous cutout, or may be perforations, for example, configured to tear constituent sheet members (here, the top sheet 11, the core-wrapping sheet 17, the back sheet 13, and the exterior sheet 14) that form the cutout. An additional cutout for expanding the dimension of the tail insertion portion 50 may be provided. In addition, the tail insertion portion 50 is not limited to the cutout, but may be an opening through which the tail can be passed. Details of the arrangement of the tail insertion portion 50 and the absorbent core 12 will be described later.

The basic configuration of the diaper 1 has been described, but the configuration of the diaper 1 is not limited to the above. For example, the following configurations are applicable: the diaper 1 is a two-piece type of diaper; the ventral waist portion 20 and the dorsal waist portion 30 are constituted by a single continuous member; and a crotch exterior member connecting the ventral waist portion 20 and the dorsal waist portion 30 is provided. In addition, the waist elastic members 23, 33 and the leg elastic members 15 may be sheet-like elastic members (stretchable films or stretchable nonwoven fabric) instead of the elastic strings.

### Operations for Putting on Underpants-shaped Disposable Pet Diaper 1

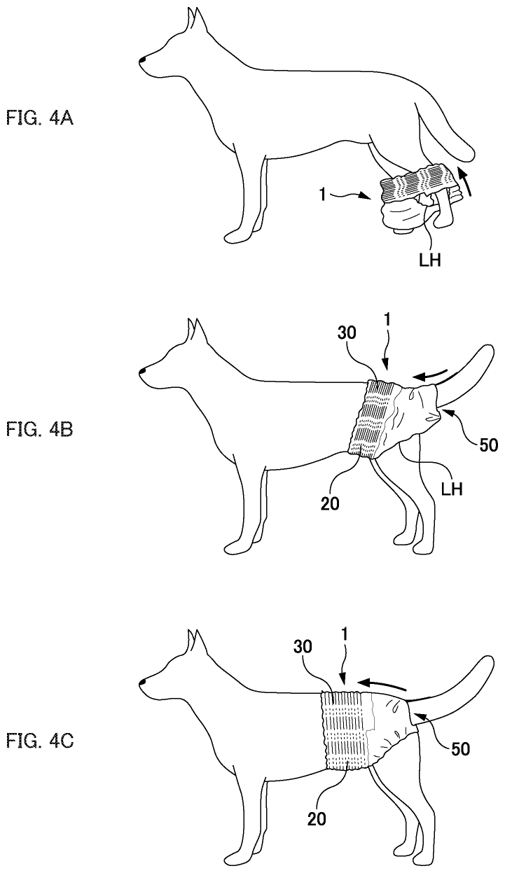

Next, the wearing operations when the diaper 1 is actually put on a pet will be described. FIGS. 4A to 4C are illustrative views of operations for putting on the diaper 1. In FIGS. 4A to 4C, an example is shown in which the pet wearing the diaper 1 is a dog. First, a diaper changer passes the pet's hind legs one by one through the leg openings LH while supporting the pet's hind legs, as shown in FIG. 4A. After that, the diaper changer pulls the diaper 1 up to the vicinity of the pet's tail and passes the pet's tail through the tail insertion portion 50, as shown in FIG. 4B. Finally, as shown in FIG. 4C, the diaper changer pulls the diaper 1 diagonally upward and toward the front side of the pet's body. When the diaper 1 is pulled up, the diaper changer pulls up the diaper 1 while firmly holding the ventral waist portion 20 and the dorsal waist portion 30 with both hands, thereby fitting the diaper 1 around the pet's waist. At the same time, the tail insertion portion 50 is pulled up to the base of the tail, thereby achieving the fit of the pet's tail.

As described above, when the diaper changer puts the underpants-shaped pet diaper on a pet, in addition to the pet's hind legs, the tail needs to be passed through the tail insertion portion 50. For example, when the diaper changer puts the diaper on a healthy and active pet, in most cases, it is difficult to put the diaper on such pet at an appropriate position. Thus, further improvement has been needed for the fit of the underpants-shaped diapers for pets.

First, a first problem when such an underpants-shaped disposable diaper is put on the pet is as follows. When the pet's hind legs are first passed through the leg openings LH and the tail is then passed through the tail insertion portion 50, the absence of the absorbent core 12 around the tail insertion portion 50 may cause the tail insertion portion 50 to lose its shape, thus making it difficult for the tail to be passed through the tail insertion portion 50.

A second problem when such an underpants-shaped disposable diaper is put on the pet is as follows. As shown in FIG. 4C, it is necessary to pull the diaper 1 diagonally upward at the end of the wearing operation, and at that time, the absorbent core 12 is likely to get caught on the pet's hind legs.

Regarding the first problem, in the diaper 1 of the present embodiment, the absorbent core 12 exists on two lateral sides of the tail insertion portion 50. Specifically, in the present embodiment, as shown in FIGS. 3A and 3B, a region 12NX where the absorbent core 12 does not exist is provided extending a predetermined distance inward and outward from the tail insertion portion 50. That is, the tail insertion portion 50 is formed by the cutout in the region 12NX, which prevents the material constituting the absorbent core 12 from leaking out from the tail insertion portion 50. As shown in FIG. 3B, the absorbent core 12 is provided outside the region 12NX, that is, on two lateral sides of the tail insertion portion 50. The presence of the absorbent core 12 on the two lateral sides of the tail insertion portion 50 increases the stiffness on the two lateral sides of the tail insertion portion 50, which makes the tail insertion portion 50 likely to maintain its shape. Accordingly, the pet's tail is more smoothly passed through the tail insertion portion 50.

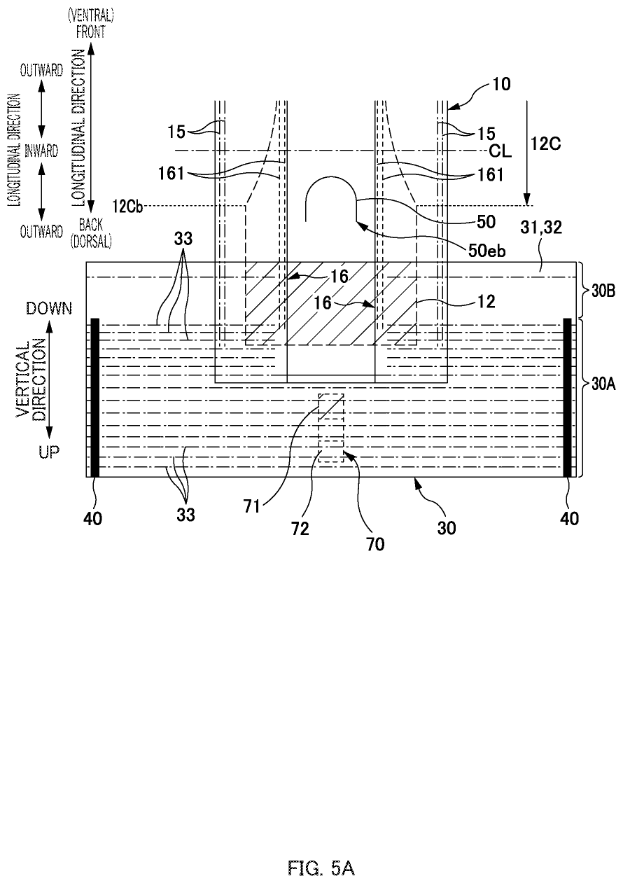

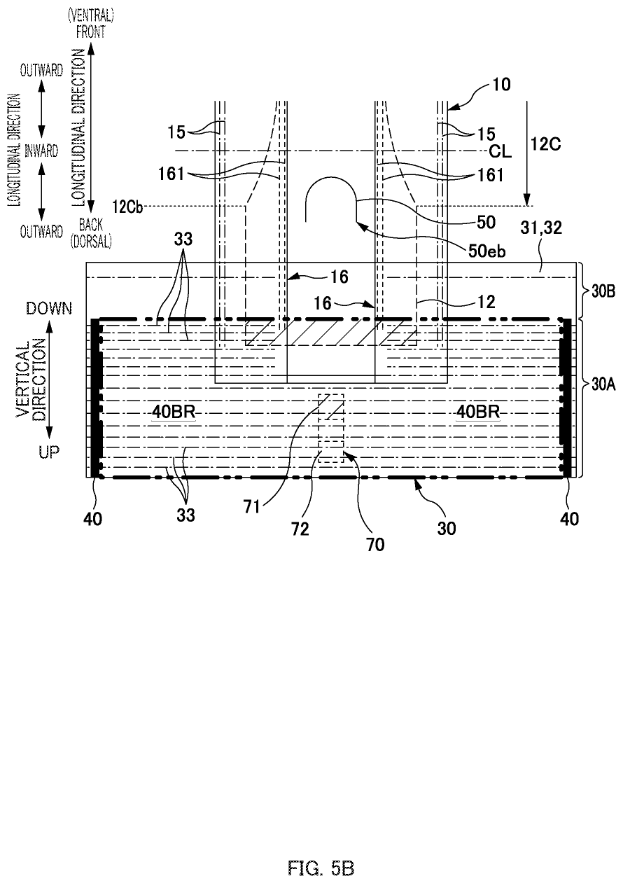

FIGS. 5A and 5B are schematic plan views of a part of the diaper 1 in the unfolded and stretched state, as viewed from the skin side. As illustrated in FIG. 5A, in the diaper 1 of the present embodiment, the absorbent core 12 and the dorsal waist portion 30 have an overlapping portion as viewed in the thickness direction of the diaper 1 (in FIG. 5A, a portion indicated by diagonal lines). When the diaper changer puts the diaper 1 on a pet, the diaper changer first passes the pet's tail through the tail insertion portion 50 (see FIG. 4B) and then needs to further pull up the diaper 1 while holding the dorsal waist portion 30 with hands of the diaper changer (see FIG. 4C). However, since the dorsal waist portion 30 and the absorbent core 12 have the overlapping portion, a force for pulling up the diaper 1 is more likely to be transmitted to the absorbent core 12. As described above, since the absorbent core 12 exists on the two lateral sides of the tail insertion portion 50, the pull-up force is also transmitted to the absorbent core 12 provided on the two sides of the tail insertion portion 50. As a result, the diaper 1 is more easily pulled up while the tail is held in a more fitted manner.

As shown in FIG. 5B, in the dorsal waist portion 30 of the diaper 1 of the present embodiment, when a region between the pair of side-joining portions 40 refers to a dorsal side-joining-portion region 40BR, the absorbent core 12 and the dorsal side-joining-portion region 40BR have an overlapping portion as viewed in the thickness direction of the diaper 1 (in FIG. 5B, a portion indicated by diagonal lines). Specifically, the dorsal side-joining-portion region 40BR corresponds to a region surrounded by: the side-joining portions 40 on the two lateral sides of the diaper 1; an upper end of the dorsal waist portion 30; and a lower end of the waist-side portion 30A (in FIG. 5B, a region surrounded by bold dotted lines). The dorsal side-joining-portion region 40BR is a region to which the pull-up force is directly applied when the diaper changer pulls up the diaper 1 while holding the dorsal waist portion 30 and the ventral waist portion 20 with the hands. When the diaper changer further pulls up the diaper while holding the dorsal waist portion 30 with the pet's tail passed through the tail insertion portion 50, the dorsal side-joining-portion region 40BR and the absorbent core 12 have the overlapping portion, thereby making the pull-up force more likely to be transmitted to the absorbent core 12. Thus, the diaper 1 is pulled up more easily. As a result, the tail is more easily fitted.

Returning to FIG. 2, regarding the second problem mentioned above, the absorbent core 12 of the present embodiment includes a constricted portion 120 located between two longitudinal end portions of the absorbent core 12. The width of the constricted portion 12C in the lateral direction is narrower than the maximum width of the absorbent core 12 in the lateral direction. The constricted portion 12C is a portion sandwiched between the pet's hind legs when the diaper 1 is put on the pet. Since the width of the constricted portion 120 in the lateral direction is narrow, the absorbent core 12 more easily fits at a position between the pet's hind legs. In addition, the presence of the constricted portion 12C makes it easier to avoid the absorbent core 12 from getting caught on the hind legs, which bend in a V-shape, when the diaper 1 is finally pulled diagonally upward at the time of wearing of the diaper 1, as shown in FIG. 4C.

As shown in FIG. 2, in the absorbent core 12, a back end 12Cb of the constricted portion 12C is positioned on the back side with respect to a longitudinal central position CL of the diaper 1. In the case where the constricted portion 12C does not extend backward (toward the dorsal side) beyond the longitudinal central position CL, the pet's hind legs are likely to get caught on the absorbent core 12 in response to movement of the hind legs. This may cause a force of shifting of the diaper 1. Then, the constricted portion 12C of the absorbent core 12 extends to the back side beyond the longitudinal central position CL, thereby reducing exertion of the force of shifting caused by movement of the pet's hind legs when the hind legs get caught on the absorbent core 12.

Similarly, as shown in FIG. 2, in the longitudinal direction, concerning the constricted portion 12C of the absorbent core 12, length L1 from the longitudinal central position CL to a front end 12Ca is longer than a length 12 from the longitudinal central position CL to the back end 12Cb. The pet's legs are likely to get caught on the front side (ventral side) of the diaper 1. Therefore, increasing the length (L1) of a part of the constricted portion 12C, which extends from the longitudinal central position CL toward the front side (ventral side) , can reduce interference with movement of the pet's legs even on the front side (ventral side). This can suppress shifting of the diaper 1 caused by the pet's legs getting caught on the absorbent core 12.

In the present embodiment, as shown in FIG. 2, the back end 12Cb of the constricted portion 12C is positioned on the front side with respect to a back end 50eb of the tail insertion portion 50. In the case where the constricted portion 12C extends beyond the back end 50eb of the tail insertion portion 50, the range where the absorbent core 12 exists on the two lateral sides of the tail insertion portion 50 is reduced, which may make it difficult to maintain the shape of the tail insertion portion 50. On the other hand, in the case where the constricted portion 12C does not extend on the dorsal side beyond the longitudinal central position CL, the absorbent core 12 may interfere with movement of the pet's legs. Since the constricted portion 12C extends on the front side beyond the back end 50eb of the tail insertion portion 50, both the maintenance of the shape of the tail insertion portion 50 and smooth passage of the pet's legs are more likely to be achieved.

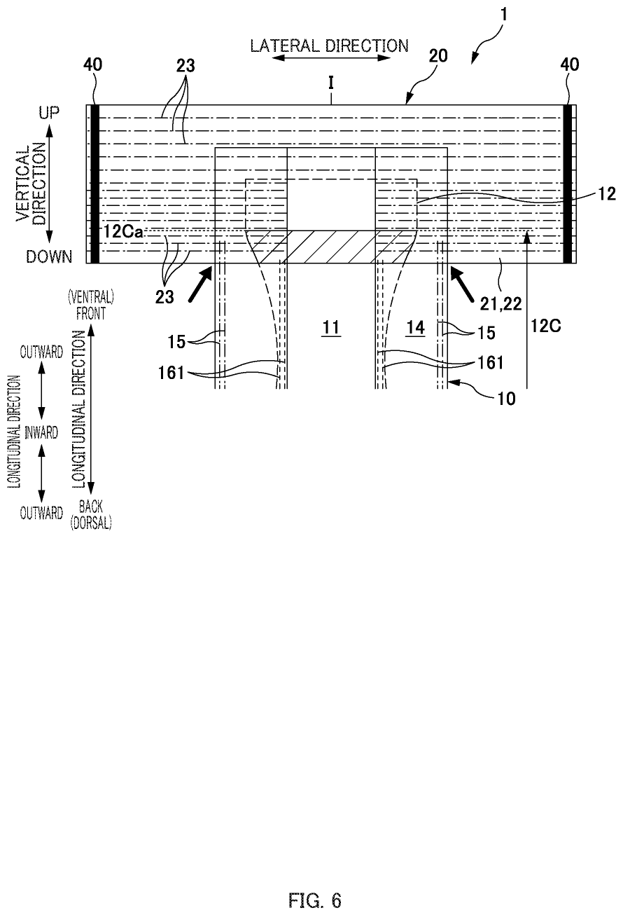

FIG. 6 is a schematic plan view of a part of the diaper 1 in the unfolded and stretched state, as viewed from the skin side. As shown in FIG. 6, in the diaper 1 of the present embodiment, the absorbent core 12 has the constricted portion 12C, and the constricted portion 12C and the ventral waist portion 20 have an overlapping portion as viewed in the thickness direction of the diaper 1 (in FIG. 6, a portion indicated by diagonal lines). The portions where the ventral waist portion 20 and the absorbent main body 10 intersect with each other (in FIG. 6, portions indicated by bold arrows) are the regions where the pet's hind legs are most likely to get caught when the diaper 1 is pulled up with the hind legs passed through the diaper 1 during wearing operation. In the case where the absorbent core 12 exists in such regions, the diaper 1 may be hindered from being pulled up. As in the present embodiment, the constricted portion 120 of the absorbent core 12 exists in the above-mentioned regions, thereby reducing the stiffness of the absorbent main body 10 in such regions. As a result, the pet's legs are less likely to get caught.

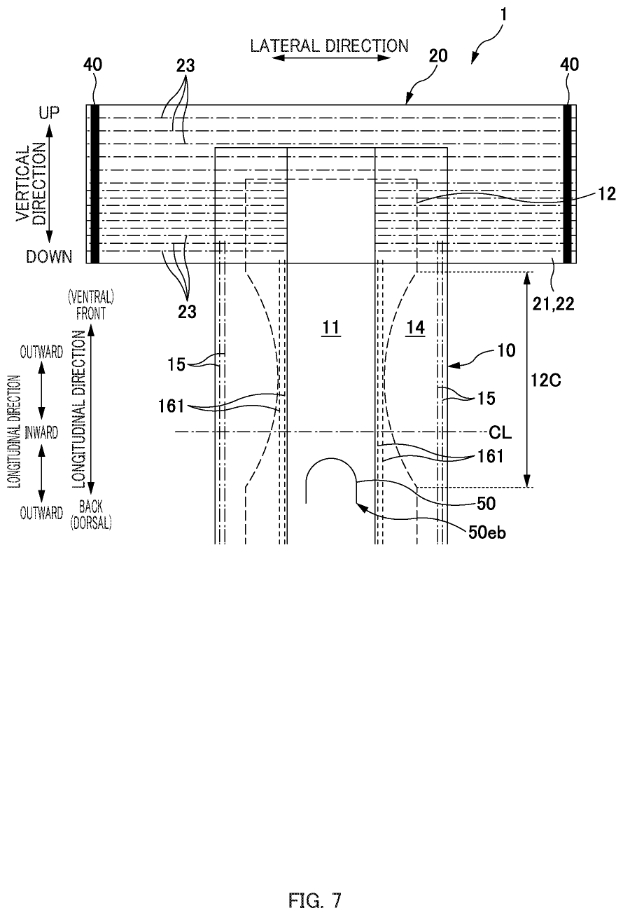

As described above, in the present embodiment, the constricted portion 12C has the portion overlapping the ventral waist portion 20 as viewed in the thickness direction, but the configuration is not limited thereto. FIG. 7 is a view of an arrangement of the absorbent core 12 and the constricted portion 12C according to a modification. In the modification, the constricted portion 12C and the ventral waist portion 20 do not overlap each other as viewed in the thickness direction of the diaper 1. When the diaper 1 is put on a male animal in particular, due to the shape of male genitalia, urine is likely to be excreted more on the ventral side compared to the crotch side. Thus, it is necessary to secure a sufficient absorption area on the ventral side. The constricted portion 12C does not overlap the ventral waist portion 20, thereby increasing the width of the absorbent core 12 on the ventral side. As a result, leakage is likely to be prevented.

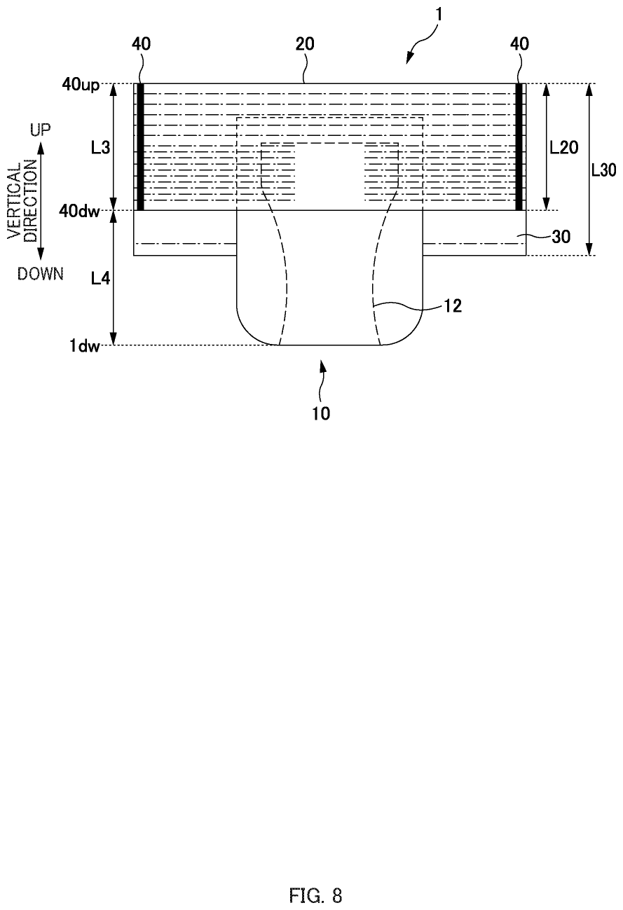

FIG. 8 is a plan view of the diaper 1 in the stretched state as viewed from the ventral side. As illustrated in FIG. 8, in the diaper 1 in the stretched state and in the vertical direction, it is preferable that a length L4 from a lower end 40dw of each of the side-joining portions 40 to a lower end 1dw of the diaper 1 is longer than a length L3 from an upper end 40up to the lower end 40dw of each of the side-joining portions 40. £ With such a configuration in which the length L4 from the lower end 40dw of each of the side-joining portions 40 to the lower end 1dw of the diaper 1 is long, that is, the configuration in which the leg openings of the diaper 1 are long, the pet's legs are more smoothly passed through the leg openings and the diaper 1 is also easily pulled up when the diaper 1 is put on the pet. In addition, the area covering the pet's waist is reduced, which improves the comfort for the pet during usage.

As described above, in the present embodiment, the ventral waist member that constitutes the ventral waist portion 20 and the dorsal waist portion that constitutes the dorsal waist portion 30 are separate members. As shown in FIG. 8, in the vertical direction, a length 120 of the ventral waist member is shorter than a length L30 of the dorsal waist member. In the case where the length (120) of the ventral waist member is excessively long, the pet's hind legs may get caught on the waist member during passage of the pet's hind legs. However, reducing the length (120) of the ventral waist member avoids interference with the passage of the pet's legs.

In the diaper 1 of the present embodiment, the ventral waist member that constitutes the ventral waist portion 20 and the dorsal waist member that constitutes the dorsal waist portion 30 each have a rectangular shape in a plan view. The rectangular ventral and rectangular dorsal waist members can further reduce the possibility that the pet's hind legs may get caught at the time of passage of the hind legs when the diaper 1 is put on the pet. In addition, the shapes of the ventral and dorsal waist members are not limited to the above-mentioned shape. For example, each of the lower end portions of the ventral and dorsal waist members in the vertical direction may have any shape such as a substantially trapezoidal shape.

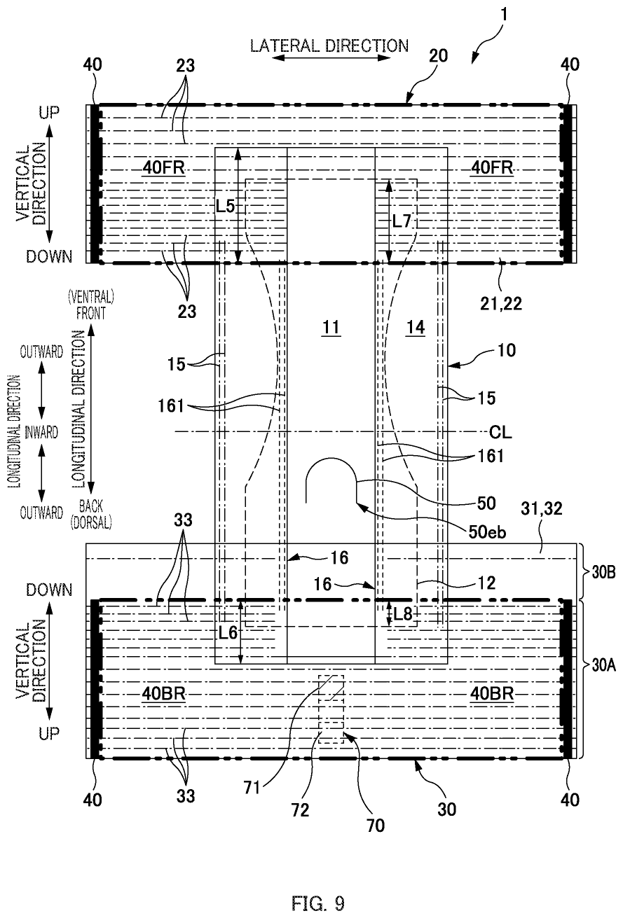

FIG. 9 is a schematic plan view of the diaper 1 in the unfolded and stretched state as viewed from the skin side. As shown in FIG. 9, in the ventral waist portion 20 of the diaper 1 of the present embodiment, a region between the pair of side-joining portions 40 refers to a ventral side-joining-portion region 40FR. Specifically, the ventral side-joining-portion region 40FR corresponds to a region surrounded by: the side-joining portions 40 on the two lateral sides of the diaper 1; and an upper end and a lower end of the ventral waist portion 20 (a region surrounded by bold dotted lines, on the ventral side in FIG. 9). Similarly to the above-mentioned dorsal side-joining-portion region 40BR in FIG. 5B, also in the dorsal waist portion 30, a region between the pair of side-joining portions 40 refers to the dorsal side-joining-portion region 40BR. In the diaper 1 of the present embodiment, it is preferable that a length 15 over which the ventral side-joining-portion region 40FR and the absorbent main body 10 overlap with respect to the longitudinal direction, is longer than a length L6 over which the dorsal side-joining-portion region 40BR and the absorbent main body 10 overlap with respect to the longitudinal direction. When the diaper 1 is put on the male animal in particular, due to the shape of the male genitalia, urine is likely to be excreted more on the ventral side compared to the crotch. However, with the above-mentioned configuration, a sufficient absorption area can be secured on the ventral side of the diaper 1, and at the same time, contraction of the diaper on the dorsal side, where the pet has thick fur, is less likely to be hindered. As a result, the diaper 1 is less likely to shift, and leakage is less likely to occur.

As in the present embodiment, concerning the ventral side-joining-portion region 40FR (dorsal side-joining-portion region 40BR) and the absorbent core 12, it is preferable that a length 17 over which the ventral side-joining-portion region FR and the absorbent core 12 overlap with respect to the longitudinal direction of the diaper 1 is longer than a length L8 over which the dorsal side-joining-portion region BR and the absorbent core 12 overlap with respect to the longitudinal direction. Accordingly, even when the diaper 1 is put on the male animal, as described above, a sufficient absorption area is secured on the ventral side, and at the same time, contraction of the diaper 1 on the dorsal side, where the pet has thick fur, is less likely to be hindered. As a result, the diaper 1 is less likely to shift, and the leakage is less likely to occur.

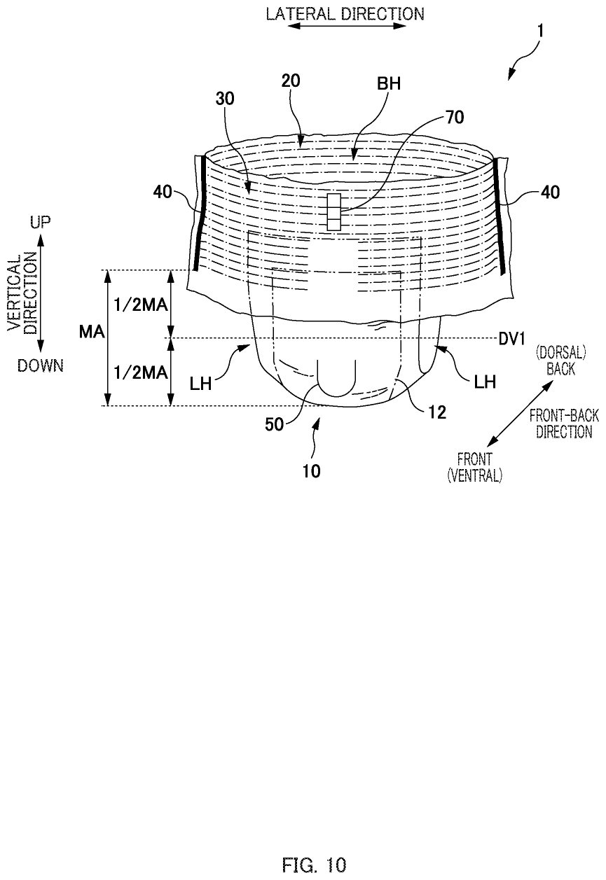

FIG. 10 is a schematic perspective view of the diaper 1 in the underpants-shaped state, as viewed from the dorsal side. As shown in FIG. 10, in the diaper 1, a region below the pair of side-joining portions 40 in the vertical direction is referred to as a crotch-side region MA. A dividing line DV1 is a line that divides the crotch-side region MA into two regions in the vertical direction. In the diaper 1, it is preferable that the tail insertion portion 50 is positioned on a lower region of the two regions obtained by dividing the crotch-side region MA in the vertical direction. With such a configuration, it becomes easier to achieve an appropriate position of the tail insertion portion 50 in conformity with the respective body shapes of pets.

As shown in FIGS. 2, 3A and 10, a post-handling tape 70 is provided on the non-skin side of the dorsal waist portion 30. The post-handling tape 70 is used to hold the diaper 1 in a rolled-up state at a time of disposing of the diaper 1 after use. The post-handling tape 70 is a substantially rectangular tape-like member (tape member) that is elongated in the vertical direction. The post-handling tape 70 has: a tape fixing portion 71 (indicated by a hatched portion in FIG. 2) on one side in the vertical direction (longitudinal direction); and an adhesive portion 72 on the other side in the vertical direction (longitudinal direction). The tape fixing portion 71 is formed with an adhesive or the like. With use of the tape fixing portion 71, the post-handling tape 70 is non-detachably fixed onto the non-skin-side surface of the non-skin-side sheet 32 of the dorsal waist portion 30. A pressure-sensitive adhesive is applied to the adhesive portion 72. Before usage of the diaper 1, a part of the post-handling tape 70 is folded with the adhesive portion 72 on the inward side. Thus, the adhesive portion 72 is not exposed to the outside, thereby protecting an adhesive surface of the adhesive portion 72.

At the time of disposing of the diaper 1 after use, the diaper 1 is rolled up in the longitudinal direction such that the absorbent main body 10 faces inward, the folded post-handling tape 70 is pulled out to expose the adhesive portion 72, and the adhesive portion 72 side is wrapped around the diaper 1. Accordingly, the diaper 1 can be held in the rolled state, and the diaper 1 can be discarded without allowing leakage of excrement or the like having adhered to the inside of the diaper 1 (absorbent main body 10). Urine excreted in the diaper 1 is more likely to flow toward the front (ventral) side relative to the crotch portion of the diaper 1. Then, the post-handling tape 70 is provided onto the non-skin-side surface of the dorsal waist portion 30, which allows the diaper 1 after use to be rolled up with the ventral waist portion 20 facing inward and finally allows the post-handling tape 70 to be fastened at the back side. Thus, the diaper changer can perform post-handling of the diaper 1 without touching urine.

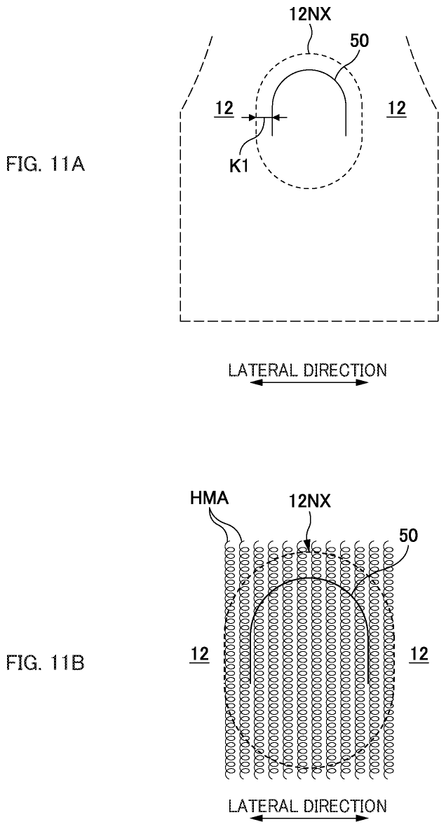

FIG. 11A is an illustrative view of an arrangement of the tail insertion portion 50 and the absorbent core 12, and FIG. 11B is an illustrative view of adhesives provided between the tail insertion portion 50 and the absorbent core 12. For convenience of explanation, in FIG. 11A, for the diaper 1 in the unfolded and stretched state, only the absorbent core 12 and the tail insertion portion 50 are schematically shown. As shown in FIGS. 3A and 3B, the region 12NX where the absorbent core 12 does not exist is provided extending a predetermined distance inward and outward from the tail insertion portion 50. In FIG. 11A, the region 12NX where the absorbent core 12 does not exist is indicated by an elliptical dotted line. The absorbent core 12 does not exist inside the region 12NX. In the present embodiment, a range of the region 12NX where the absorbent core 12 does not exist is merely an example, and the present disclosure is not limited to such a range. However, it is preferable that, in the lateral direction, a distance K1 from an outer edge of the tail insertion portion 50 to the absorbent core 12, which exists on the two lateral sides of the tail insertion portion 50, is longer than the maximum thickness of the absorbent core 12. The distance K1 from the outer edge of the tail insertion portion 50 to the absorbent core 12 makes it possible to prevent tear and leakage of the sheet materials positioned between the outer edge and the absorbent core 12 (in the present embodiment, the top sheet 11, the core-wrapping sheet 17, the back sheet 13, and the exterior sheet 14).

As a method of measuring the maximum thickness of the absorbent core 12, for example, the following method can be used. First, in the diaper 1 in the unfolded state, a portion where the absorbent core 12 exists is cut along the thickness direction, and an enlarged image of the cut surface of such a portion is captured using a digital microscope VHX-1000 manufactured by Keyence Corporation, for example. Based on this enlarged image, the spacing dimension from the skin-side end to the non-skin-side end of the absorbent core 12 is measured. In the same way, the measurement is performed at ten locations, and the maximum value is regarded as the maximum thickness of the absorbent core 12.

FIG. 11B is an enlarged view of the region surrounding the tail insertion portion 50, and similarly to FIG. 11A, the region 12NX where the absorbent core 12 does not exist is indicated by an elliptical dotted line. As shown in FIG. 11B, hot-melt adhesives HMAs are provided in the region 12NX where the absorbent core 12 does not exist. The hot-melt adhesives HMAS join the non-skin-side surface of a skin-side core-wrapping sheet 17a on the skin side with respect to the absorbent core 12 (a sheet member on the skin side with respect to the absorbent core 12) and the skin-side surface of a non-skin-side core-wrapping sheet 17b on the non-skin side (a sheet member on the non-skin-side). In the case where the core-wrapping sheet 17 is not provided, in the region 12NX where the absorbent core 12 does not exist, the non-skin-side surface the top sheet 11 and the skin-side surface of the back sheet 13 are joined with the hot-melt adhesives HMAs.

Specifically, in a range between the lateral outer edge of the tail insertion portion 50 and the absorbent core 12 provided on the two lateral sides of the tail insertion portion 50 (in the lateral direction, a range between the outer edge of the tail insertion portion 50 and the outer edge of the region 12NX), there are also the hot-melt adhesives HMAs that join the non-skin-side surface of the skin-side core-wrapping sheet 17a (sheet member on the skin side with respect to the absorbent core 12) and the skin-side surface of the non-skin-side core-wrapping sheet 17b (sheet member on the non-skin side) . The region between the outer edge of the tail insertion portion 50 and the absorbent core 12 is joined with the hot-melt adhesives HMAs, thereby making the absorbent core 12 less likely to leak from the tail insertion portion 50 to the outside. It is preferable that at least two beads of the hot-melt adhesive HMA are applied to the region between the outer edge of the tail insertion portion 50 and the absorbent core 12 provided on the two lateral sides of the tail insertion portion 50. This can further prevent the material that constitutes the absorbent core 12 from projecting through the tail insertion portion 50.

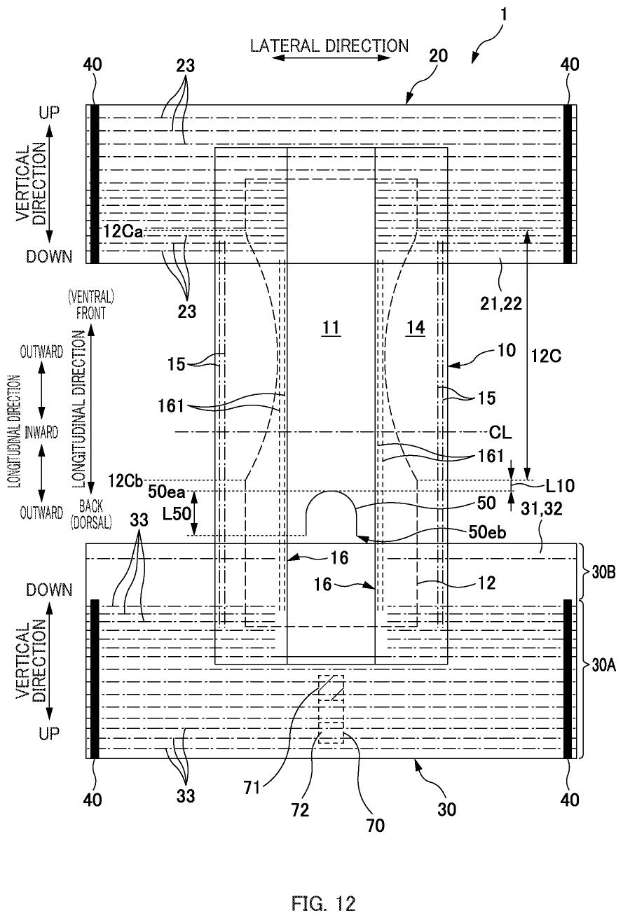

FIG. 12 is a view of arrangement of the tail insertion portion 50 according to a modification. In the modification, the absorbent core 12 also has the constricted portion 12C. In the modification, the tail insertion portion 50 is positioned on the back side with respect to a back end 12Cb of the constricted portion 12C. Since the tail insertion portion 50 does not overlap the constricted portion 12C, a greater amount of the absorbent core 12 can be secured on the two lateral sides of the tail insertion portion 50. As a result, the pull-up force to be transmitted to the absorbent core 12 when the diaper 1 is pulled up, is more easily transmitted to the region around the tail insertion portion 50 as well.

As in the modification, in the configuration in which the tail insertion portion 50 is positioned on the back side with respect to the back end 12Cb of the constricted portion 12C, it is preferable that, in the longitudinal direction, a length L10 from the back end 12Cb of the constricted portion 120 to a front end 50ea of the tail insertion portion 50 is shorter than a length 150 from the front end 50ea to the back end 50eb of the tail insertion portion 50 (see FIG. 12). In the case where the tail insertion portion 50 does not overlap the constricted portion 12C, the pull-up force is more easily transmitted to the tail insertion portion 50. On the other hand, the presence of the constricted portion 12C improves the fit of the leg openings of the diaper 1. Thus, it is preferable that the constricted portion 12C is provided up to position close to the tail insertion portion 50, thereby reducing the likelihood of interfering with movement of the legs.

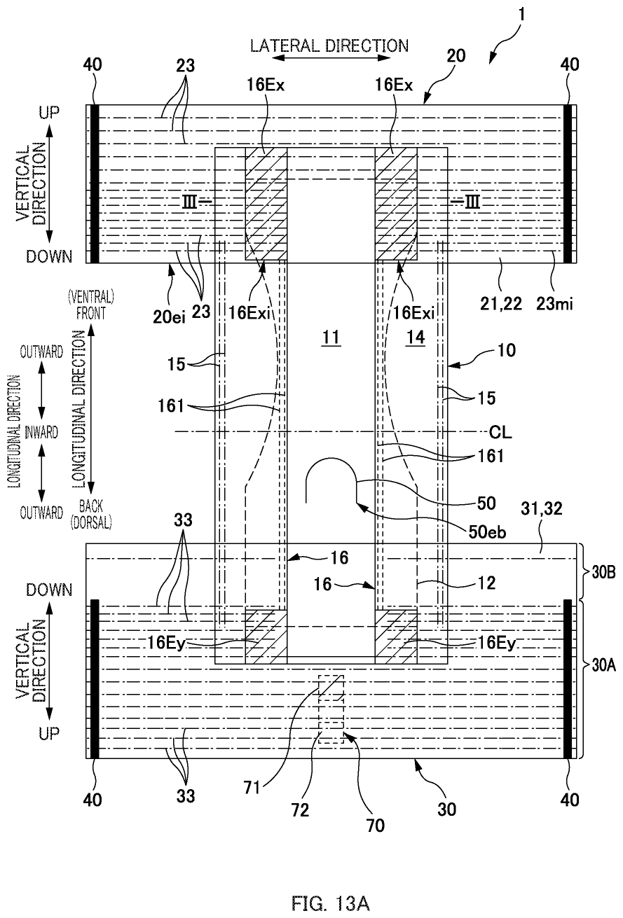

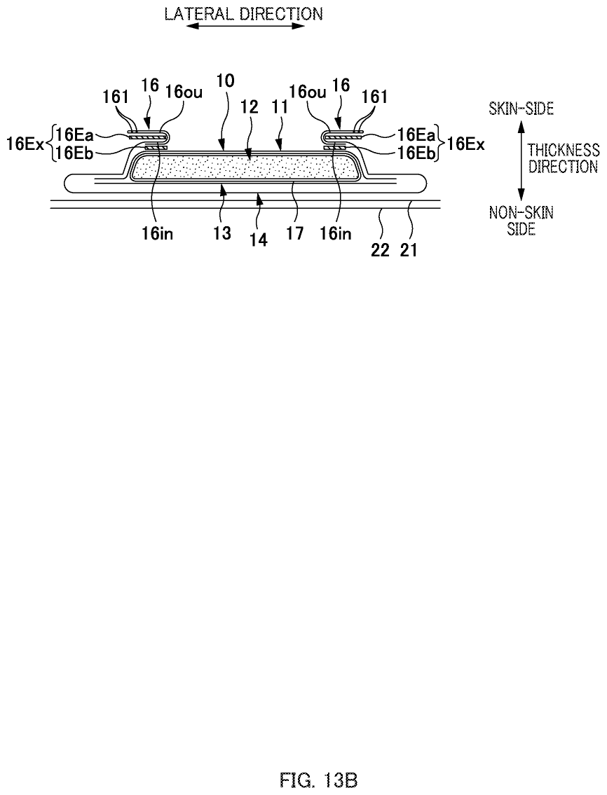

FIG. 13A is a schematic plan view illustrating the fixing of two longitudinal end portions of each of the leakproof-wall portions 16, and FIG. 13B is a schematic cross-sectional view taken along a line III-III in FIG. 13A. The ventral (front) end portions of the leakproof-wall portions 16 of the absorbent main body 10 in the longitudinal direction are fixed by a pair of ventral-end-portion fixing portions 16Ex, 16Ex, respectively, such that the leakproof-wall portions 16 cannot rise toward the skin side of the absorbent main body 10. The ventral-end-portion fixing portions 16Ex, 16Ex are formed with an adhesive such as a hot-melt adhesive. As shown in FIG. 13B, in the leakproof-wall portions 16, the ventral-end-portion fixing portions 16Ex each have a skin-side fixing portion 16Ea and a non-skin-side fixing portion 16Eb. The skin-side fixing portion 16Ea fixes a skin-side portion 16ou on the skin side in the thickness direction to a non-skin-side portion 16 in on the non-skin side in the thickness direction with respect to the skin-side portion 16ou. The non-skin-side fixing portion 16Eb fixes the non-skin-side portion 16 in of the leakproof-wall portion 16 to the top sheet 11 with use of an adhesive, or the like.

Similarly, the dorsal (back) end portions of the leakproof-wall portions 16 in the longitudinal direction are fixed by a pair of dorsal-end-portion fixing portions 16Ey, 16Ey, respectively, such that the leakproof-wall portions 16 cannot rise toward the skin side of the absorbent main body 10. The dorsal-end-portion fixing portions 16Ey, 16Ey are formed with an adhesive such as a hot-melt adhesive. Thus, in the longitudinal direction, the portion of the exterior sheet 14 between the ventral-end-portion fixing portions 16Ex and the dorsal-end-portion fixing portions 16Ey is the portion where the leakproof-wall portions 16 can rise up.

In the diaper 1 of the present embodiment, as shown in FIG. 13A, in the longitudinal direction, an inward end 16Exi of each of the ventral-end-portion fixing portions 16Ex is positioned inside a waist elastic member 23mi, which is the innermost waist elastic member among the plurality of waist elastic members 23 provided in the ventral waist portion 20. During usage of the diaper 1, the leakproof-wall portions 16 rise up in response to contraction of the waist elastic members 23 of the ventral waist portion 20, thereby preventing leakage. In the case where, in each of the leakproof-wall portions 16, the inward end 16Exi of the ventral-end-portion fixing portion 16Ex is positioned outside the waist elastic member 23mi in the longitudinal direction (positioned on the upper side in the vertical direction), the leakproof-wall portions 16 are less likely to rise up. However, the inward end 16Exi is positioned inside the innermost waist elastic member 23mi in the longitudinal direction (positioned on the lower side in the vertical direction), the leakproof-wall portions 16 more easily rise up.

The position of the ventral-end-portion fixing portion 16Ex is not limited to the above-mentioned position. For example, the inward end 16Exi of the ventral-end-portion fixing portion 16Ex may be positioned inside an inward end 20ei of the ventral waist portion 20 in the longitudinal direction. Since the inward end 16Exi of the ventral-end-portion fixing portion 16Ex is positioned further inward in the longitudinal direction, the leakproof-wall portions 16 more easily rise up. This can prevent the leakage.

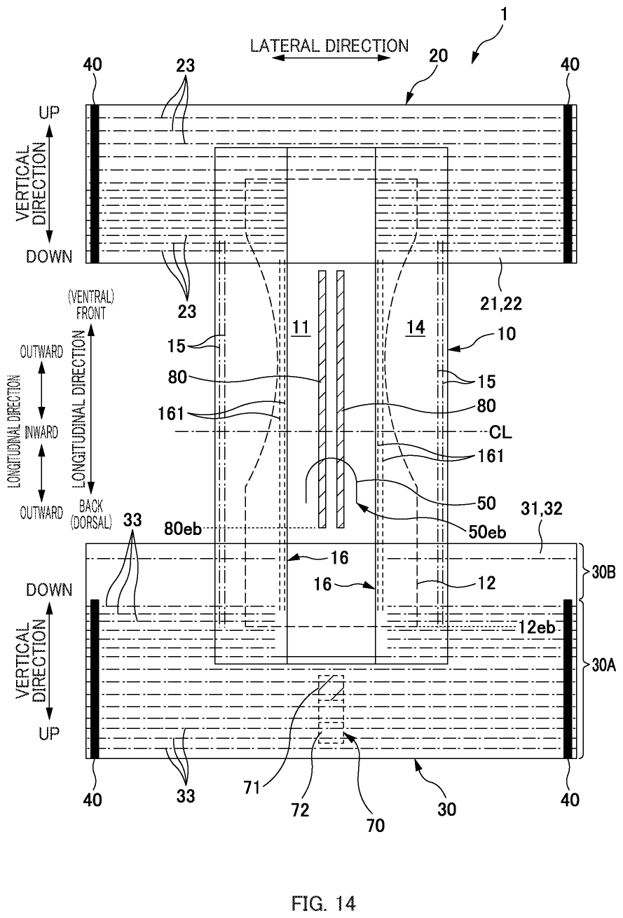

FIG. 14 is an explanatory view of a diaper 1 according to another modification. In the modification shown in FIG. 14, the diaper 1 in the unfolded and stretched state further includes indicators 80 that are positioned at a central position of the absorbent main body 10 in the lateral direction and arranged along the longitudinal direction. The indicators 80 change colors upon contact with excrement. Specifically, the indicators 80 are each a detector for detecting at least one of urine and feces, and are preferably provided between the absorbent core 12 and the back sheet 13 in the thickness direction. The indicators 80 may be each an indicator including a PH indicator, which is used in conventional diapers. For example, the pH of excrement is used as a reaction factor, and the discharge of urine or feces is detected when the indicators 80 exhibit a color reaction upon contact with urine or feces. That is, the indicators 80 each contain a pigment, and the pigment develops and changes color, thereby making the diaper changer or the like detect the discharge of urine and feces.

In the modification, as one example, two indicators 80 are provided along the longitudinal direction and spaced apart in the lateral direction, but the arrangement and number of indicators 80 can be changed as appropriate depending on the type of excrement to be detected (urine or feces) and the amount of excrement. It is preferable that the indicators 80 arranged in such a manner are provided so as to span the longitudinal central position CL of the diaper 1. Since the indicators 80 are provided to span the longitudinal central position CL, changes in the indicators 80 can be easily visually recognized in the state where the diaper 1 is put on a pet.

In addition, in the modification of FIG. 14, the indicators 80 and the tail insertion portion 50 have an overlapping portion as viewed in the thickness direction of the diaper 1 (in FIG. 14, a direction penetrates the paper plane). The diaper 1 is a diaper for pets, and the ventral waist portion faces downward during usage. Thus, the change of the indicators 80 on the ventral side are less likely to be visually recognized. Then, the indicators 80 extend to a position where the indicators 80 overlap the tail insertion portion 50, and thus, the diaper changer can more easily visually recognize changes of the indicators 80 in the state where the diaper 1 is put on the pet.

It is preferable that the indicators 80 are provided such that a back end 80eb of each of the indicators 80 is positioned on the front side with respect to a back end 12 eb of the absorbent core 12, in the longitudinal direction of the diaper 1 in the unfolded and stretched state shown in FIG. 14. Since the indicators 80 detect excretion of urine or feces, the indicators 80 need not be provided over the range where the absorbent core 12 exists. However, in the case where the indicators 80 extend to a position close to the back end 12eb of the absorbent core 12, the diaper changer easily visually recognize changes of the indicators 80.

### Others

The above-mentioned embodiments have been described in order to facilitate the understanding of the present disclosure, not to interpret the present disclosure in a limited manner. The present disclosure may variously be changed or altered without departing from its gist and encompass equivalents thereof.

In the above-mentioned embodiments, in the diaper 1 in the unfolded and stretched state, the absorbent core 12 is provided not only on the two lateral sides of the tail insertion portion 50, but also on the two longitudinal sides (front and back sides), but the configuration is not limited thereto. For example, the absorbent core 12 need not exist on the back (dorsal) side of the tail insertion portion 50 in the longitudinal direction. That is, the tail insertion portion 50 may be formed such that the back end 50eb of the tail insertion portion 50 extends to the back end of the absorbent core 12. When the absorbent core 12 does not exist in the region around the tail insertion portion 50, the shape of the tail insertion portion 50 is distorted and the pet's tail is less likely to be passed through the tail insertion portion 50. As long as the absorbent core 12 is provided on the two lateral sides of the tail insertion portion 50 and on the front side (ventral side) in the longitudinal direction, the shape of the tail insertion portion 50 can be maintained during wearing of the diaper 1.

### REFERENCE SIGNS LIST

1: underpants-shaped disposable pet diaper (diaper)
1dw: lower end
10: absorbent main body
11: top sheet
12: absorbent core
12C: constricted portion
12Ca: front end
12Cb: back end
13: back sheet
14: exterior sheet
15: leg elastic member
16: leakproof-wall portion
16Ea: skin-side fixing portion
16Eb: non-skin-side fixing portion
16Ex: ventral-end-portion fixing portion
16Exi: inward end
16Ey: dorsal-end-portion fixing portion
16in: non-skin-side portion
16ou: skin-side portion
17: core-wrapping sheet
17a: skin-side core-wrapping sheet
17b: non-skin-side core-wrapping sheet
20: ventral waist portion
20ei: inward end
21: skin-side sheet
22: non-skin-side sheet
23: waist elastic member
30: dorsal waist portion
30A: waist-side portion
30B: crotch-side portion
31: skin-side sheet
32: non-skin-side sheet
33: waist elastic member
40: side-joining portion
40BR: dorsal side-joining-portion region
40dw: lower end
40FR: ventral side-joining-portion region
40up: upper end
50: tail insertion portion
50ea: front end
50eb: back end
70: post-handling tape
71: tape fixing portion
72: adhesive portion
80: indicator
80eb: back end
161: leakproof-wall elastic member

1. An underpants-shaped disposable pet diaper having a vertical direction, a lateral direction, and a front-back direction that intersect with each other, the underpants-shaped disposable pet diaper comprising:
an absorbent main body including an absorbent core;
a ventral waist portion positioned on a front side in the front-back direction; and
a dorsal waist portion positioned on a back side in the front-back direction,
two lateral side portions of the ventral waist portion and two lateral side portions of the dorsal waist portion being joined by a pair of side-joining portions,
the absorbent main body including a tail insertion portion through which a tail is passed,
the absorbent core being provided on two lateral sides of the tail insertion portion.

2. The underpants-shaped disposable pet diaper according to claim 1, wherein
in an unfolded and stretched state,
the absorbent core and the dorsal waist portion have an overlapping portion as viewed in a thickness direction of the underpants-shaped disposable pet diaper.

3. The underpants-shaped disposable pet diaper according to claim 1, wherein
in the dorsal waist portion, when a region between the pair of side-joining portions refers to a dorsal side-joining-portion region,
the absorbent core and the dorsal side-joining-portion region have an overlapping portion as viewed in a thickness direction of the underpants-shaped disposable pet diaper.

4. An underpants-shaped disposable pet diaper having a vertical direction, a lateral direction, and a front-back direction that intersect with each other, the underpants-shaped disposable pet diaper comprising:
an absorbent main body including an absorbent core;
a ventral waist portion positioned on a front side in the front-back direction; and
a dorsal waist portion positioned on a back side in the front-back direction,
two lateral side portions of the ventral waist portion and two lateral side portions of the dorsal waist portion being joined by a pair of side-joining portions,
the absorbent main body including a tail insertion portion through which a tail is passed,
in an unfolded and stretched state,
the absorbent core including a constricted portion located between two longitudinal end portions of the absorbent core,
a width of the constricted portion in the lateral direction being narrower than a maximum width of the absorbent core in the lateral direction.

5. The underpants-shaped disposable pet diaper according to claim 4, wherein
in an unfolded and stretched state,
the constricted portion and the ventral waist portion have an overlapping portion as viewed in a thickness direction of the underpants-shaped disposable pet diaper.

6. The underpants-shaped disposable pet diaper according to claim 4, wherein
in an unfolded and stretched state,
the constricted portion and the ventral waist portion do not overlap as viewed in a thickness direction of the underpants-shaped disposable pet diaper.

7. The underpants-shaped disposable pet diaper according to claim 4, wherein,
in an unfolded and stretched state,
the front side corresponds to a longitudinal one side of the underpants-shaped disposable pet diaper,
the back side corresponds to a longitudinal other side of the underpants-shaped disposable pet diaper, and
a back end of the constricted portion is positioned on the back side with respect to a longitudinal central position of the underpants-shaped disposable pet diaper.

8. The underpants-shaped disposable pet diaper according to claim 7, wherein in the longitudinal direction,
concerning the constricted portion,
a length from the longitudinal central position to a front end of the constricted portion
is longer than
a length from the longitudinal central position to the back end of the constricted portion.

9. The underpants-shaped disposable pet diaper according to claim 1, wherein
in a stretched state, and in the vertical direction,
a length from a lower end of each of the side-joining portions to a lower end of the underpants-shaped disposable pet diaper
is longer than
a length from an upper end of each of the side-joining portions to the lower end of each of the side-joining portions.

10. The underpants-shaped disposable pet diaper according to claim 1, wherein
a ventral waist member constituting the ventral waist portion and a dorsal waist member constituting the dorsal waist portion are separate members, and
in a stretched state, and in the vertical direction,
a length of the ventral waist member is shorter than a length of the dorsal waist member.

11. The underpants-shaped disposable pet diaper according to claim 10, wherein
in an unfolded and stretched state,
the ventral waist member and the dorsal waist member each have a rectangular shape in a plan view.

12. The underpants-shaped disposable pet diaper according to claim 1, wherein
in an unfolded and stretched state,
when a ventral side-joining-portion region refers to a region between the pair of side-joining portions in the ventral waist portion, and when a dorsal side-joining-portion region refers to a region between the pair of side-joining portions in the dorsal waist portion,
a length over which the ventral side-joining-portion region and the absorbent main body overlap with respect to a longitudinal direction of the underpants-shaped disposable pet diaper
is longer than
a length over which the dorsal side-joining-portion region and the absorbent main body overlap with respect to the longitudinal direction.

13. The underpants-shaped disposable pet diaper according to claim 1, wherein
in an unfolded and stretched state,
when a ventral side-joining-portion region refers to a region between the pair of side-joining portions in the ventral waist portion, and when a dorsal side-joining-portion region refers to a region between the pair of side-joining portions in the dorsal waist portion,
a length over which the ventral side-joining-portion region and the absorbent core overlap with respect to a longitudinal direction of the underpants-shaped disposable pet diaper
is longer than
a length over which the dorsal side-joining-portion region and the absorbent core overlap with respect to the longitudinal direction.

14. The underpants-shaped disposable pet diaper according to claim 1, wherein
when a crotch-side region refers to a region below the pair of side-joining portions in the vertical direction,
the tail insertion portion is positioned on a lower region of two regions obtained by dividing the crotch-side region in the vertical direction.

15. The underpants-shaped disposable pet diaper according to claim 1, wherein
a post-handling tape is provided on a non-skin side of the dorsal waist portion,
the post-handling tape being used to hold the underpants-shaped disposable pet diaper in a rolled-up state when disposing of the underpants-shaped disposable pet diaper after use.

16. The underpants-shaped disposable pet diaper according to claim 1, wherein
the ventral waist portion and the dorsal waist portion each include a plurality of waist elastic members,
the plurality of waist elastic members stretching and contracting in the lateral direction,
the underpants-shaped disposable pet diaper in an unfolded state has a longitudinal direction, a lateral direction, and a thickness direction that intersect with each other,
the underpants-shaped disposable pet diaper includes a pair of leakproof-wall portions provided on two lateral sides of the absorbent main body,
the pair of leakproof-wall portions being capable of rising toward a skin side in the thickness direction,
ventral end portions of the pair of leakproof-wall portions in the longitudinal direction are fixed by a pair of ventral-end-portion fixing portions, respectively, such that the leakproof-wall portions do not rise toward a skin side of the absorbent main body,
dorsal end portions of the pair of leakproof-wall portions in the longitudinal direction are fixed by a pair of dorsal-end-portion fixing portions, respectively, such that the leakproof-wall portions do not rise toward the skin side of the absorbent main body, and
in the longitudinal direction, an inward end of each of the ventral-end-portion fixing portions is positioned inside an innermost elastic member among the plurality of waist elastic members provided in the ventral waist portion.

17. The underpants-shaped disposable pet diaper according to claim 16, wherein
in the longitudinal direction, the inward end of each of the ventral-end-portion fixing portions is positioned inside an inward end of the ventral waist portion.

18. The underpants-shaped disposable pet diaper according to claim 1, further comprising
an indicator changing colors upon contact with excrement, wherein
in an unfolded and stretched state,
the indicator is provided to span a longitudinal central position of the underpants-shaped disposable pet diaper.

19. The underpants-shaped disposable pet diaper according to claim 18, wherein
the indicator and the tail insertion portion have an overlapping portion as viewed in a thickness direction of the underpants-shaped disposable pet diaper.

20. The underpants-shaped disposable pet diaper according to claim 18, wherein
the front side corresponds to a longitudinal one side of the underpants-shaped disposable pet diaper,
the back side corresponds to a longitudinal other side of the underpants-shaped disposable pet diaper, and
in the longitudinal direction, a back end of the indicator is positioned on the front side with respect to a back end of the absorbent core.

21. The underpants-shaped disposable pet diaper according to claim 1, wherein
in an unfolded and stretched state,
in the lateral direction, a distance from an outer edge of the tail insertion portion to the absorbent core provided on the two lateral sides of the tail insertion portion
is longer than
a maximum thickness of the absorbent core.

22. The underpants-shaped disposable pet diaper according to claim 21, wherein
a hot-melt adhesive is provided in a region from the outer edge of the tail insertion portion to the absorbent core provided on the two lateral sides of the tail insertion portion,
the hot-melt adhesive joining a non-skin-side surface of a skin-side sheet member and a skin-side surface of a non-skin-side sheet member,
the skin-side sheet member being provided on a skin side with respect to the absorbent core, the non-skin-side sheet member being provided on a non-skin side with respect to the absorbent core.

23. The underpants-shaped disposable pet diaper according to claim 1, wherein
in an unfolded and stretched state,
the absorbent core includes a constricted portion located between two longitudinal end portions of the absorbent core,
a width of the constricted portion in the lateral direction is narrower than a maximum width of the absorbent core in the lateral direction,
the front side corresponds to a longitudinal one side of the underpants-shaped disposable pet diaper,
the back side corresponds to a longitudinal other side of the underpants-shaped disposable pet diaper, and
a back end of the constricted portion is positioned on the front side with respect to a back end of the tail insertion portion.

24. The underpants-shaped disposable pet diaper according to claim 1, wherein
in an unfolded and stretched state,
the absorbent core includes a constricted portion located between two longitudinal end portions of the absorbent core,
a width of the constricted portion in the lateral direction is narrower than a maximum width of the absorbent core in the lateral direction,
the front side corresponds to a longitudinal one side of the underpants-shaped disposable pet diaper,
the back side corresponds to a longitudinal other side of the underpants-shaped disposable pet diaper, and
the tail insertion portion is positioned on the back side with respect to a back end of the constricted portion.

25. The underpants-shaped disposable pet diaper according to claim 24, wherein
in the longitudinal direction, a length from the back end of the constricted portion to a front end of the tail insertion portion
is shorter than
a length from the front end of the tail insertion portion to a back end of the tail insertion portion.
